(19) United States
(12) Patent Application Publication
(10) Pub. No.: US 2023/0078463 A1
(43) Pub. Date: Mar. 16, 2023

(54) SELF-FILLING FRICTION STIR PROCESSING TOOL AND METHODS OF USING THE SAME

(71) Applicant: OHIO STATE INNOVATION FOUNDATION, Columbus, OH (US)

(72) Inventor: Xun Liu, Columbus, OH (US)

(21) Appl. No.: 17/943,748

(22) Filed: Sep. 13, 2022

Related U.S. Application Data
(60) Provisional application No. 63/243,379, filed on Sep. 13, 2021.

(51) Int. Cl. B23K 20/12

(52) U.S. Cl. CPC B23K 20/1255; B23K 20/1225; B23K 20/128

(57) ABSTRACT

Disclosed are tools for friction stir processing and methods of using the same. Also disclosed herein are methods of repairing surface defects using the disclosed friction stir processing tools.

### CROSS-REFERENCE TO RELATED APPLICATIONS

This application claims the benefit of U.S. Provisional Application No. 63/243,379, filed Sep. 13, 2021, the content of which is incorporated herein by reference in its entirety.

### FIELD

The present invention relates generally to tools used in friction stir welding and to methods of using such tools. The present invention also relates to systems comprising friction stir welding tools and working pieces.

### BACKGROUND

Friction stir welding (FSW) is a popular solid-state joining process that uses a non-consumable tool to join workpieces without melting them. Friction stir processing (FSP), which is a variant of friction stir welding, is often used to repair surface cracks and locally refine microstructures. However, for both of these processes, a hole formed at the leading edge of the weld pool after retracting the tool pin, also known as a keyhole, is an unavoidable detect, generating stress concentration and corrosion issues.

The current technologies used to refill the keyhole focus more on the spot welding configuration. One main category relies on a specially designed machine where the shoulder and pin of the tool can move independently. Such an approach increases the cost of equipment and can hardly be applied to a butt welding configuration. Moreover, the process becomes more difficult when high temperature materials involved in the stirring nugget, such as steel and titanium, due to the associated high welding force and resultant tool wear (FIGS. 2A-2B). Therefore, an economical, reliable, and universally applicable process needs to be developed.

Thus, there is a need for tools and methods that can provide economical, reliable, and universally applicable processes for repairing and providing workpieces without the presence of cracks and defects. These needs and other needs are at least partially satisfied by the present invention.

### SUMMARY

The present disclosure is generally directed to a friction stir processing tool comprising: a) a non-consumable shoulder having an aperture; and b) a sacrificial pin having a proximal end portion and a distal end portion; wherein the proximal end portion is positioned within the aperture, and wherein at least a portion of the distal end portion of the pin serves as a filling into a stirring region of at least one defect on a surface of a workpiece when used in a stir processing step; and wherein the sacrificial pin comprises a material substantially compatible with the workpiece.

In still further aspects, the distal end portion of the sacrificial pin comprises at least one predetermined cutting feature configured to facilitate an initial plunge stage of the friction stir processing tool.

In yet still further aspects, the sacrificial pin can have one or more threads configured to enhance the flow of the material into a stirring nugget in the workpiece.

In still further exemplary aspects, the sacrificial pin is configured to be substantially consumed such that at the end of the stir processing step, substantially no keyhole is left on the workpiece surface

Also disclosed herein is a method comprising inserting a friction stir processing tool into at least one defect on a surface of a workpiece, wherein the friction stir processing tool comprises: i. a non-consumable shoulder having an aperture; and ii. a sacrificial pin having a proximal end portion and a distal end portion; wherein the proximal end portion is positioned within the aperture; and wherein the step of inserting comprises inserting a distal end portion of the pin into the at least one defect at a predetermined speed such that at least a portion of the distal end portion of the pin is consumed to fill up the at least one defect.

In still further exemplary aspects, the step of inserting is repeated an n times until the at least one defect is substantially filled. While in other aspects, the step of inserting is repeated an n times until the distal end portion of the pin is substantially consumed.

In still further aspects, also disclosed herein is a system comprising: a) a processing tool comprising: i. a non-consumable shoulder having an aperture; and ii. a sacrificial pin having a proximal end portion and a distal end portion; and b) a workpiece having at least one defect; wherein the proximal end portion of the pin is positioned within the aperture of the shoulder, wherein at least a portion of the distal end portion of the pin serves as a filling into a stirring region of at least one defect on a surface of the workpiece when used in a stir processing step; and wherein the sacrificial pin comprises a material substantially compatible with the workpiece.

Additional aspects of the invention will be set forth, in part, in the detailed description, figures, and claims which follow, and in part will be derived from the detailed description or can be learned by practice of the invention. It is to be understood that both the foregoing general description and the following detailed description are exemplary and explanatory only and are not restrictive of the invention as disclosed.

### BRIEF DESCRIPTION OF FIGURES

FIGS. 1A-1B depict an exemplary tool in disassembled view of an exemplary pin and a shoulder (FIG. 1A) and assembled view where the exemplary pin is positioned within the shoulder (FIG. 1B).

FIGS. 2A-2B depict a schematic showing tool wear at different welding lengths.

Additional aspects of the invention will be set forth, in part, in the detailed description, figures, and claims which follow, and in part will be derived from the detailed description or can be learned by practice of the invention. It is to be understood that both the foregoing general description and the following detailed description are exemplary and explanatory only and are not restrictive of the invention as disclosed.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

In this specification and in the claims that follow, reference will be made to a number of terms, which shall be defined to have the following meanings:

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a metal part” includes two or more such metal parts, reference to “an energy source” includes two or more such energy sources, and the like.

Throughout the description and claims of this specification, the word “comprise” and other forms of the word, such as “comprising” and “comprises,” means including but not limited to, and are not intended to exclude, for example, other additives, components, integers, or steps. Furthermore, it is to be understood that the terms comprise, comprising, and comprises as they relate to various aspects, elements, and features of the disclosed invention also include the more limited aspects of “consisting essentially of” and “consisting of.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein, the term “and/or” includes any and all combinations of one or more of the associated listed items.

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or a section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein are interpreted accordingly.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to indicate that the recited component is not intentionally batched and added to the composition but can be present as an impurity along with other components being added to the composition. In such aspects, the term “substantially free” is intended to refer to trace amounts that can be present in the batched components, for example, it can be present in an amount that is less than about 1% by weight, e.g., less than about 0.5% by weight, less than about 0.1% by weight, less than about 0.05% by weight, or less than about 0.01% by weight of the stated material, based on the total weight of the composition.

As used herein, the term “substantially,” in, for example, the context “substantially identical” or “substantially similar” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art using only routine experimentation. Although the operations of exemplary embodiments of the disclosed method may be described in a particular sequential order for convenient presentation, it should be understood that disclosed embodiments can encompass an order of operations other than the particular, sequential order disclosed. For example, operations described sequentially may, in some cases, be rearranged or performed concurrently. Further, descriptions and disclosures provided in association with one particular embodiment are not limited to that embodiment and may be applied to any embodiment disclosed.

Moreover, for the sake of simplicity, the attached figures may not show the various ways (readily discernable, based on this disclosure, by one of ordinary skill in the art) in which the disclosed system, method, and apparatus can be used in combination with other systems, methods, and apparatuses. Additionally, the description sometimes uses terms such as “produce” and “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

### Friction Stir Processing Tool

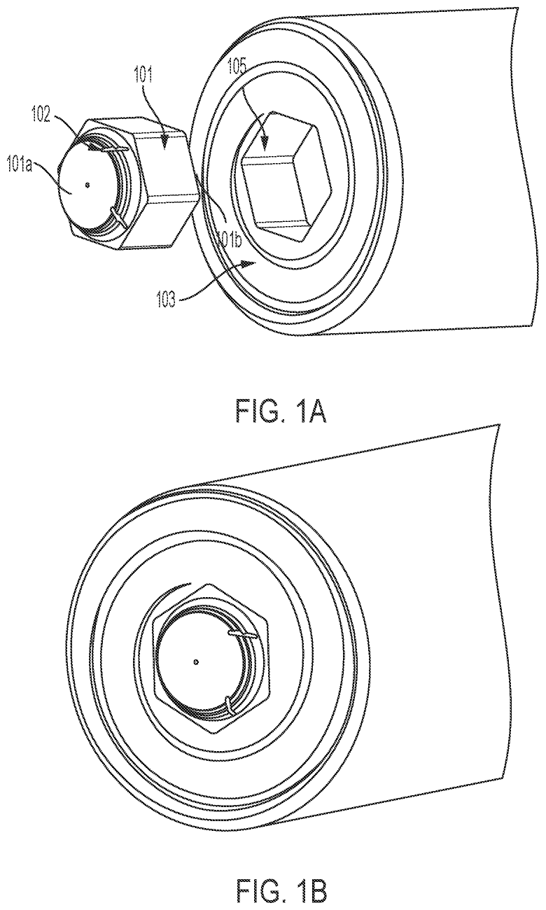

Disclosed herein is a friction stir processing tool, as shown in FIGS. 1A-1B, comprising a non-consumable part and a consumable part. In such aspects, the non-consumable part comprises a non-consumable shoulder 103. In certain aspects, the non-consumable shoulder can comprise an aperture 105.

While in other aspects, the consumable part comprises a consumable pin 101. It is understood that the terms consumable and sacrificial can be used interchangeably.

In certain aspects, the sacrificial or consumable pin can be defined by a proximal end portion 101b and a distal end portion 101a. In some aspects, the proximal end portion can be positioned within the aperture (FIG. 1B). It is understood that the aperture has a predetermined geometry substantially matching a predetermined geometry of the proximal end portion of the pin.

While in still further aspects, the distal end portion of the sacrificial pin can serve as a filling that is supplied into a stirring region of at least one defect on a surface of a workpiece. It is understood that such defects on the surface of the workpiece can be formed during the stir processing step, or they can exist prior to the processing or can be formed during the lifetime of the workpiece. It is understood that there is no limitation on how and when the defect on the surface of the workpiece was formed. In some exemplary and unlimiting aspects, the at least one defect can comprise a surface crack, a keyhole opening, porosities, or a combination thereof. It is understood that the at least one defect can have any dimensions.

In still further aspects, the sacrificial pin can comprise a material that is substantially compatible with the workpiece. It is understood that the substantially compatible material does not necessarily mean that the sacrificial material and the workpiece material are the same. In some aspects, the sacrificial material is substantially similar to the workpiece material. While in other aspects, the sacrificial material is the same as the workpiece material. However, there are also aspects where the sacrificial material is different from the workpiece material but is compatible with such. It is understood that the compatibility can be defined by the specific application and can be based, for example, on anti-corrosion properties, mechanical strength, chemical content, and such.

In still further aspects, the sacrificial pin can comprise at least one predetermined cutting feature 102. Such a predetermined cutting feature can be positioned on the distal end portion of the sacrificial pin that is in contact with the workpiece. The predetermined cutting feature can be configured to facilitate an initial plunge stage, during which the tool gradually moves into the workpiece to a certain depth. It is understood that the sacrificial pin is configured to be inserted at a predetermined depth. The depth value can be dependent on a specific type of defect, defect's depth, workpiece material, and/or the specific use of the workpiece.

In still further aspects, the distal portion of the sacrificial pin can be configured to be inserted into the workpiece at a predetermined speed, force, and/or torque.

It is understood that the sacrificial pin can have any shape that allows obtaining the desired result. In certain aspects, the sacrificial pin can have a triangular, rectangle, cylindrical, cone, or frustum shape.

In yet still further aspects, the sacrificial pin can have one or more threads configured to enhance the flow of the material into a stirring nugget in the workpiece.

In still further aspects, the sacrificial pin is configured to be substantially consumed such that at the end of the stir processing step, substantially no keyhole is left on the workpiece surface. In still further aspects, at least 20%, at least 30%, at least 40%, at least 50%, at least 60%, at least 70%, at least 80%, at least 90%, or 100% of an initial length of the sacrificial pin is configured to be consumed as the filling of the at least one defect.

In some aspects, wherein the non-consumable shoulder and the sacrificial pin can be defined by a shoulder dimension and a pin dimension, wherein the shoulder dimension comprises a shoulder diameter; wherein the pin dimension comprises a pin diameter, and/or a pin length, and wherein the shoulder and pin dimensions are effective to substantially match a dimension of the at least one defect in the workpiece. For example, for friction stir processing to repair surface cracks, the crack length and depth are the critical parameters in determining the tool dimensions.

In still further aspects, the non-consumable shoulder can comprise one or more refractory materials. For example, and without limitations, the one or more refractory materials can comprise WC, Si₃N, polycrystalline cubic boron nitride (PCBN), W—Re, BN, or any combination thereof.

In still further aspects, the shoulder can have a surface that is flat, concave, convex, with groove features on it, or any combination thereof.

It is understood that the sacrificial pin, as disclosed herein, supplies the fillings into the stirring region such that by the end of the process and retraction of the tool, no keyhole or any other defect is left on the workpiece surface. Without wishing to be bound by any theory, it is also understood that this extra amount of materials added to the stirring nugget can create some compressive stress, which is beneficial for fatigue life and alleviate other issues, for example, stress corrosion cracking of the workpiece.

Also disclosed herein is a system comprising: a disclosed above processing tool and a workpiece having at least one defect; wherein the proximal end portion of the pin is positioned within the aperture of the shoulder, wherein at least a portion of the distal end portion of the pin serves as a filling into a stirring region of at least one defect on a surface of the workpiece when used in a stir processing step; and wherein the sacrificial pin comprises a material substantially compatible with the workpiece.

In still further aspects, the workpiece can be made of any metal or metal alloy known in the art and useful for the desired application. In yet still further aspects, the workpiece can comprise Al, Mg, Ti, Cu, Ni, steel, or any alloys thereof.

### Methods of Forming an Impact Weld

Also disclosed herein is a method comprising: inserting the disclosed herein friction stir processing tool into at least one defect on a surface of a workpiece. In such aspects, the step of inserting comprises inserting the distal end portion of the disclosed herein pin into the at least one defect at a predetermined speed such that at least a portion of the distal end portion of the pin is consumed to fill up the at least one defect.

In still further aspects, the step of inserting can be repeated an n times until the at least one defect is substantially filled. While in other aspects, the step of inserting can be repeated an n times until the distal end portion of the pin is substantially consumed. Yet, in still further aspects, if the distal end portion of the pin is substantially consumed, but the at least one defect is not substantially filled, the method can further comprise replacing the sacrificial pin with a further sacrificial pin and repeating the step of inserting until the at least one defect is filled.

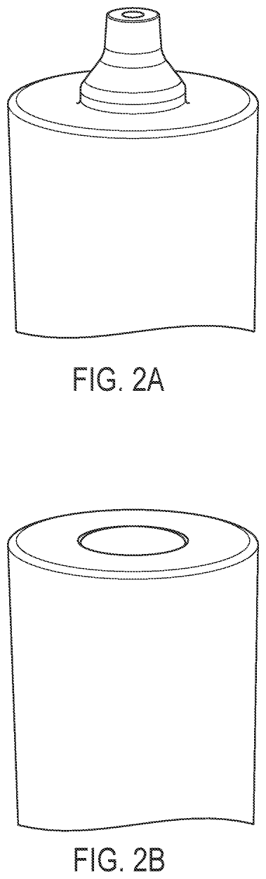

It is understood that there are three stages of tool use. In a first stage, the cutting feature of the pin wears rapidly since the workpiece is cold and material deformation resistance is high. In the second stage, the wear is at a relatively stable rate, which is determined by the processing parameters, such as tool rotating and welding speed, plunging depth or forging force, as well as the material of the workpiece. The final stage is when the pin fractures from the shoulder and are embedded in the workpiece. Exemplary wear of the tool during its use is shown in FIGS. 2A-2B.

In still further aspects, the methods disclosed herein can comprise steps of collecting unconsumed portions of the pin. In yet further aspects, the unconsumed portion of the pin can be further used to form a further sacrificial pin.

In still further aspects, the force and torque needed for the use of the tool can be measured, for example, and without limitations, with a dynamometer. While in other aspects, the temperature of the tool and the workpiece can be measured with thermocouples embedded in the tool, which can be either at the end of the tool shank or near the shoulder region.

In still further aspects, the tool and methods disclosed herein can be used for local microstructure modifications of the workpiece material in addition or instead of correcting defects on the surface of the workpiece.

The above specification and examples provide a complete description of the structure and use of illustrative embodiments. Although certain embodiments have been described above with a certain degree of particularity or with reference to one or more individual embodiments, those skilled in the art could make numerous alterations to the disclosed embodiments without departing from the scope of this invention. As such, the various illustrative embodiments of the devices are not intended to be limited to the particular forms disclosed. Rather, they include all modifications and alternatives falling within the scope of the claims, and embodiments other than the one shown may include some or all of the features of the depicted embodiment. For example, components may be omitted or combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### Exemplary Aspects:

Aspect 1: A friction stir processing tool comprising: a) a non-consumable shoulder having an aperture; and b) a sacrificial pin having a proximal end portion and a distal end portion; wherein the proximal end portion is positioned within the aperture, and wherein at least a portion of the distal end portion of the pin serves as a filling into a stirring region of at least one defect on a surface of a workpiece when used in a stir processing step; and wherein the sacrificial pin comprises a material substantially compatible with the workpiece.

Aspect 2: The friction stir processing tool of Aspect 1, wherein the distal end portion of the sacrificial pin comprises at least one predetermined cutting feature configured to facilitate an initial plunge stage of the friction stir processing tool.

Aspect 3: The friction stir processing tool of any one of Aspects 1-2, wherein the distal end portion of the sacrificial pin is configured to be inserted into the workpiece at a predetermined speed, force, and/or torque.

Aspect 4: The friction stir processing of any one of Aspects 1-3, wherein the sacrificial pin is configured to be inserted at a predetermined depth.

Aspect 5: The friction stir processing tool of any one of Aspects 1-4, wherein the sacrificial pin has a triangular, rectangle, cylindrical, cone, or frustum shape.

Aspect 6: The friction stir processing tool of any one of Aspects 1-5, wherein the sacrificial pin has one or more threads configured to enhance the flow of the material into a stirring nugget in the workpiece.

Aspect 7: The friction stir processing tool of any one of Aspects 1-6, wherein the aperture has a predetermined geometry substantially matching a predetermined geometry of the proximal end portion of the pin.

Aspect 8: The friction stir processing tool of any one of Aspects 1-7, wherein the non-consumable shoulder and the sacrificial pin are defined by a shoulder dimension and a pin dimension, wherein the shoulder dimension comprises a shoulder diameter; wherein the pin dimension comprises a pin diameter, and/or a pin length, and wherein the shoulder and pin dimensions are effective to substantially match a dimension of the at least one defect in the workpiece.

Aspect 9: The friction stir processing tool of any one of Aspects 1-8, wherein the sacrificial pin is configured to be substantially consumed such that at the end of the stir processing step, substantially no keyhole is left on the workpiece surface.

Aspect 10: The friction stir processing tool of any one of Aspects 1-9, wherein the at least one defect comprises a surface crack, a keyhole opening, porosities, or a combination thereof.

Aspect 11: The friction stir processing tool of any one of Aspects 1-10, wherein at least 20% of an initial length of the sacrificial pin is configured to be consumed as the filling.

Aspect 12: The friction stir processing tool of any one of Aspects 1-11, wherein at least 50% of an initial length of the sacrificial pin is configured to be consumed as the filling.

Aspect 13: The friction stir processing tool of any one of Aspects 1-12, wherein at least 80% of an initial length of the sacrificial pin is configured to be consumed as the filling.

Aspect 14: The friction stir processing tool of any one of Aspects 1-13, wherein the non-consumable shoulder comprises one or more refractory materials.

Aspect 15: The friction stir processing tool of Aspect 14, wherein the one or more refractory materials comprise WC, Si₃N, polycrystalline cubic boron nitride (PCBN), W—Re, BN, or any combination thereof.

Aspect 16: A method comprising: inserting a friction stir processing tool into at least one defect on a surface of a workpiece, wherein the friction stir processing tool comprises: i. a non-consumable shoulder having an aperture; and ii. a sacrificial pin having a proximal end portion and a distal end portion; wherein the proximal end portion is positioned within the aperture; and wherein the step of inserting comprises inserting a distal end portion of the pin into the at least one defect at a predetermined speed such that at least a portion of the distal end portion of the pin is consumed to fill up the at least one defect.

Aspect 17: The method of Aspect 16, wherein the sacrificial pin comprises a material substantially compatible with the workpiece.

Aspect 18: The method of Aspect 16 or 17, wherein the step of inserting is repeated an n times until the at least one defect is substantially filled.

Aspect 19: The method of Aspect 16 or 17, wherein the step of inserting is repeated an n times until the distal end portion of the pin is substantially consumed.

Aspect 20: The method of Aspect 19, wherein when the distal end portion of the pin is substantially consumed, but the at least one defect is not substantially filled, the method further comprises replacing the sacrificial pin with a further sacrificial pin and repeating the step of inserting until the at least one defect is filled.

Aspect 21: The method of any one of Aspects 16-20, wherein the distal end portion of the sacrificial pin comprises at least one predetermined cutting feature configured to facilitate an initial plunge stage of the friction stir processing tool.

Aspect 22: The method of any one of Aspects 16-21, wherein the sacrificial pin is inserted at a predetermined depth.

Aspect 23: The method of any one of Aspects 16-22, wherein the sacrificial pin has a triangular, cone, cylindrical, or frustum shape.

Aspect 24: The method of any one of Aspects 16-23, wherein the sacrificial pin has one or more threads configured to enhance the flow of the material into a stirring nugget in the workpiece.

Aspect 25: The method of any one of Aspects 16-24, wherein the aperture has a predetermined geometry substantially matching a predetermined geometry of the proximal end portion of the pin.

Aspect 26: The method of any one of Aspects 16-25, wherein the non-consumable shoulder and the sacrificial pin are defined by a shoulder dimension and a pin dimension, wherein the shoulder dimension comprises a shoulder diameter; wherein the pin dimension comprises a pin diameter, and/or a pin length, and wherein the shoulder and pin dimensions are effective to substantially match a dimension of the at least one defect in the workpiece.

Aspect 27: The method of any one of Aspects 16-26, wherein the at least one defect comprises a surface crack, a keyhole opening, porosities, or a combination thereof.

Aspect 28: The method of any one of Aspects 16-27, wherein the non-consumable shoulder comprises one or more refractory materials.

Aspect 29: The method of Aspect 28, wherein the one or more refractory materials comprise WC, Si₃N, polycrystalline cubic boron nitride (PCBN), W—Re, BN, or any combination thereof.

Aspect 30: The method of any one of Aspects 16-29, further comprising collecting unconsumed portions of the pin.

Aspect 31: The method of Aspect 30, recycling unconsumed portions of the pin to form a further sacrificial pin.

Aspect 32: A system comprising: a) a processing tool comprising: i. a non-consumable shoulder having an aperture; and ii. a sacrificial pin having a proximal end portion and a distal end portion; and b) a workpiece having at least one defect; wherein the proximal end portion of the pin is positioned within the aperture of the shoulder, wherein at least a portion of the distal end portion of the pin serves as a filling into a stirring region of at least one defect on a surface of the workpiece when used in a stir processing step; and wherein the sacrificial pin comprises a material substantially compatible with the workpiece.

What is claimed is:

1. A friction stir processing tool comprising:
a) a non-consumable shoulder having an aperture; and
b) a sacrificial pin having a proximal end portion and a distal end portion;
wherein the proximal end portion is positioned within the aperture, and
wherein at least a portion of the distal end portion of the pin serves as a filling into a stirring region of at least one defect on a surface of a workpiece when used in a stir processing step; and wherein the sacrificial pin comprises a material substantially compatible with the workpiece.

2. The friction stir processing tool of claim 1, wherein the distal end portion of the sacrificial pin comprises at least one predetermined cutting feature configured to facilitate an initial plunge stage of the friction stir processing tool.

3. The friction stir processing tool of claim 1, wherein the distal end portion of the sacrificial pin is configured to be inserted into the workpiece at a predetermined speed, force, and/or torque; and wherein the sacrificial pin is configured to be inserted at a predetermined depth.

4. The friction stir processing tool of claim 1, wherein the sacrificial pin has a triangular, rectangle, cylindrical, cone, or frustum shape.

5. The friction stir processing tool of claim 1, wherein the sacrificial pin has one or more threads configured to enhance the flow of the material into a stirring nugget in the workpiece.

6. The friction stir processing tool of claim 1, wherein the aperture has a predetermined geometry substantially matching a predetermined geometry of the proximal end portion of the pin.

7. The friction stir processing tool of claim 1, wherein the non-consumable shoulder and the sacrificial pin are defined by a shoulder dimension and a pin dimension,
wherein the shoulder dimension comprises a shoulder diameter;
wherein the pin dimension comprises a pin diameter, and/or a pin length, and
wherein the shoulder and pin dimensions are effective to substantially match a dimension of the at least one defect in the workpiece.

8. The friction stir processing tool of claim 1, wherein the sacrificial pin is configured to be substantially consumed such that at the end of the stir processing step, substantially no keyhole is left on the workpiece surface.

9. The friction stir processing tool of claim 1, wherein the at least one defect comprises a surface crack, a keyhole opening, porosities, or a combination thereof.

10. The friction stir processing tool of claim 1, wherein at least 20% of an initial length of the sacrificial pin is configured to be consumed as the filling.

11. The friction stir processing tool of claim 1, wherein the non-consumable shoulder comprises one or more refractory materials, and wherein the one or more refractory materials comprise WC, Si₃N, polycrystalline cubic boron nitride (PCBN), W—Re, BN, or any combination thereof.

12. A method comprising:
inserting a friction stir processing tool into at least one defect on a surface of a workpiece, wherein the friction stir processing tool comprises:
i) a non-consumable shoulder having an aperture; and
ii) a sacrificial pin having a proximal end portion and a distal end portion;
wherein the proximal end portion is positioned within the aperture;
wherein the step of inserting comprises inserting a distal end portion of the pin into the at least one defect at a predetermined speed such that at least a portion of the distal end portion of the pin is consumed to fill up the at least one defect; and
wherein the sacrificial pin comprises a material substantially compatible with the workpiece.

13. The method of claim 12, wherein the step of inserting is repeated an n times until the at least one defect is substantially filled, or wherein the step of inserting is repeated an n times until the distal end portion of the pin is substantially consumed.

14. The method of claim 13, wherein when the distal end portion of the pin is substantially consumed, but the at least one defect is not substantially filled, the method further comprises replacing the sacrificial pin with a further sacrificial pin and repeating the step of inserting until the at least one defect is filled.

15. The method of claim 12, wherein the distal end portion of the sacrificial pin comprises at least one predetermined cutting feature configured to facilitate an initial plunge stage of the friction stir processing tool.

16. The method of claim 12, wherein the sacrificial pin has one or more threads configured to enhance the flow of the material into a stirring nugget in the workpiece.

17. The method of claim 12, wherein the non-consumable shoulder and the sacrificial pin are defined by a shoulder dimension and a pin dimension,
wherein the shoulder dimension comprises a shoulder diameter;
wherein the pin dimension comprises a pin diameter, and/or a pin length, and
wherein the shoulder and pin dimensions are effective to substantially match a dimension of the at least one defect in the workpiece.

18. The method of claim 12, further comprising collecting unconsumed portions of the pin.

19. The method of claim 18, further comprising recycling unconsumed portions of the pin to form a further sacrificial pin.

20. A system comprising:
a) a processing tool comprising:
i) a non-consumable shoulder having an aperture; and
ii) a sacrificial pin having a proximal end portion and a distal end portion; and
b) a workpiece having at least one defect;
wherein the proximal end portion of the pin is positioned within the aperture of the shoulder,
wherein at least a portion of the distal end portion of the pin serves as a filling into a stirring region of at least one defect on a surface of the workpiece when used in a stir processing step; and
wherein the sacrificial pin comprises a material substantially compatible with the workpiece.
